(19) United States
(12) Patent Application Publication
(10) Pub. No.: US 2026/0075436 A1
(43) Pub. Date: Mar. 12, 2026

(54) TECHNIQUES TO OBTAIN OPTIMUM CONNECTION QUALITY FOR A FIXED WIRELESS ACCESS DEVICE

(71) Applicant: T-MOBILE INNOVATIONS LLC, Overland Park, KS (US)

(72) Inventors: Kosol JINTASERANEE, Millbrae, CA (US); Mark J. BONN, Granite Bay, CA (US)

(21) Appl. No.: 18/882,523

(22) Filed: Sep. 11, 2024

(51) Int. Cl. H04W 16/18; H04W 36/30; H04W 52/02

(52) U.S. Cl. CPC H04W 16/18; H04W 36/30; H04W 52/0235

(57) ABSTRACT

Methods, media, and systems are provided for facilitating the determination of a placement for a fixed wireless access (FWA) device. A connection quality for a connection between the FWA device and a node, associated with a wireless telecommunications network, is determined at a first location. A predicted connection quality is determined for a second location. The second location is provided to a user should the predicted connection quality for the second location be an improvement over the connection quality at the first location.

### SUMMARY

A high-level overview of various aspects of the invention are provided here for that reason, to provide an overview of the disclosure and to introduce a selection of concepts that are further described in the detailed-description section below. This summary is not intended to identify key features or essential features of the claimed subject matter, nor is it intended to be used as an aid in isolation to determine the scope of the claimed subject matter. The present disclosure is directed, in part, to facilitating optimum placement location of a fixed wireless access (FWA) device, substantially as shown in and/or described in connection with at least one of the figures, and as set forth more completely in the claims.

In aspects set forth herein, and at a high level, the technology described herein relates to facilitating optimal placement location of an FWA device to enhance connection quality. In aspects, the FWA device may determine its location, a connection quality, and a predicted connection quality from network and map data. In aspects, the FWA device may calculate a second placement location to enhance the connection quality. The location of the second placement location may then be communicated to a user device, so that a user associated with the user device may physically move the FWA device. The FWA device may repeat this process until a set number of attempts are made, and/or the determined connection quality is within a threshold of the predicted connection quality.

### BRIEF DESCRIPTION OF THE SEVERAL VIEWS OF THE DRAWINGS

Implementations of the present disclosure are described in detail below with reference to the attached drawing figures, wherein:

FIG. 1 depicts an example operating environment for an FWA device connected to a wireless network and providing network access to user equipment, in accordance with aspects herein;

FIG. 2 depicts an example operating environment for an FWA device connected to a wireless network while facilitating optimum placement locations at a user site;

FIG. 3 depicts an exemplary FWA device having a graphic display illustrating aspects herein for determining an optimum placement location of the FWA device at a user site;

FIG. 4A depicts an exemplary graphic display of an FWA device, the exemplary graphic display for determining an optimum placement location of the FWA device at a user site;

FIG. 4B depicts another exemplary graphic display of an FWA device, the exemplary graphic display for determining an optimum placement location of the FWA device at a user site;

FIG. 4C depicts another exemplary graphic display of an FWA device, the exemplary graphic display for determining an optimum placement location of the FWA device at a user site;

FIG. 4D depicts another exemplary graphic display of an FWA device, the exemplary graphic display for determining an optimum placement location of the FWA device at a user site;

FIG. 5 illustrates an example flowchart of a method for facilitating optimal placement location of an FWA device, in accordance with aspects herein;

FIG. 6 illustrates an example flowchart for facilitating optimal connection quality for an FWA device, in accordance with aspects herein;

FIG. 7 illustrates another example flowchart for facilitating optimal placement location of an FWA device, in accordance with aspects herein; and

FIG. 8 depicts an example computing environment suitable for use in implementations of the present disclosure, in accordance with aspects herein.

### DETAILED DESCRIPTION

The subject matter of embodiments of the invention is described with specificity herein to meet statutory requirements. However, the description itself is not intended to limit the scope of this patent. Rather, the inventors have contemplated that the claimed subject matter might be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described.

Various technical terms, acronyms, and shorthand notations are employed to describe, refer to, and/or aid the understanding of certain concepts pertaining to the present disclosure. Unless otherwise noted, said terms should be understood in the manner they would be used by one with ordinary skill in the telecommunication arts. An illustrative resource that defines these terms may be found in Newton's Telecom Dictionary, (e.g., 32d Edition, 2022).

In addition, words such as “a” and “an,” unless otherwise indicated to the contrary, may also include the plural as well as the singular. Thus, for example, the constraint of “a feature” is satisfied where one or more features are present. Furthermore, the term “or” includes the conjunctive, the disjunctive, and both (a or b thus includes either a or b, as well as a and b).

Unless specifically stated otherwise, descriptors such as “first,” “second,” and “third,” for example, are used herein without imputing or otherwise indicating any meaning of priority, physical order, arrangement in a list, or ordering in any way, but are merely used as labels to distinguish elements for ease of understanding the disclosed examples. In some examples, the descriptor “first” may be used to refer to an element in the detailed description, while the same element may be referred to in a claim with a different descriptor such as “second” or “third.” In such instances, it should be understood that such descriptors are used merely for identifying those elements distinctly that might, for example, otherwise share a same name. Further, the term “some” may refer to “one or more.” Additionally, an element in the singular may refer to “one or more.”

The term “combination” (e.g., a combination thereof, combinations thereof) may refer to, for example, “at least one of A, B, or C”; “at least one of A, B, and C”; “at least two of A, B, or C” (e.g., AA, AB, AC, BB, BA, BC, CC, CA, CB); “each of A, B, and C”; and may include multiples of A, multiples of B, or multiples of C (e.g., CCABB, ACBB, ABB, etc.). Other combinations may include more or less than three options associated with the A, B, and C examples.

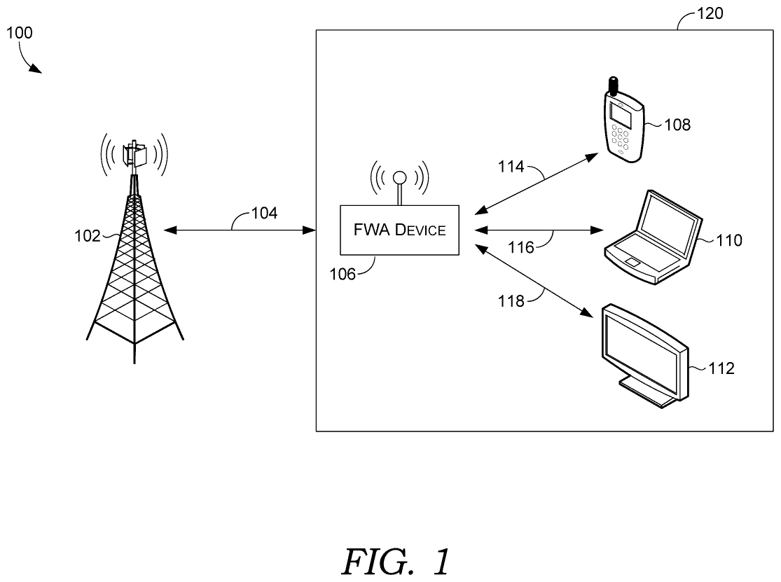

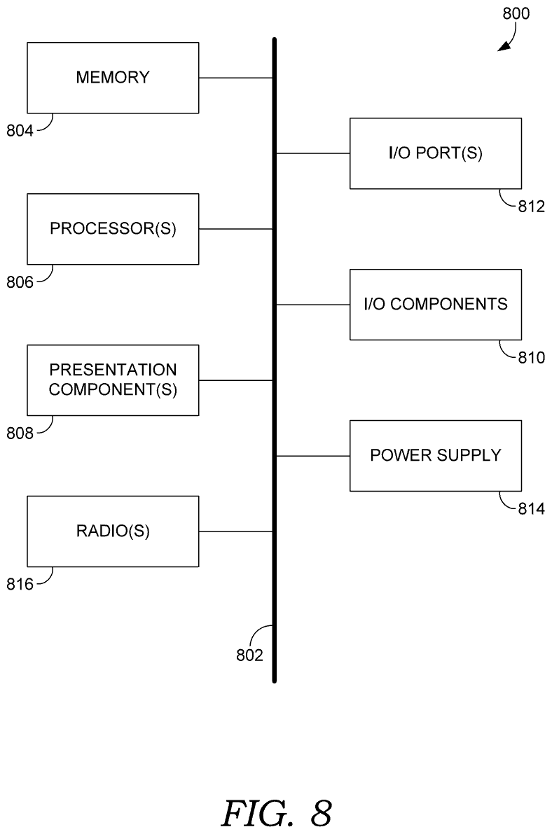

Additionally, a “user device,” as used herein, is a device that has the capability of using a wireless communications network, and may also be referred to as a “computing device,” “mobile device,” “user equipment,” “wireless communication device,” “device,” or “UE.” A user device, in some aspects, may take on a variety of forms, such as a PC, a laptop computer, a tablet, a mobile phone, a PDA, a server, or any other device that is capable of communicating with other devices (e.g., by transmitting or receiving a signal) using a wireless communication. A user device may be, in an embodiment, similar to user devices 108, 110, or 112 described herein with respect to FIG. 1. A user device may also be, in another embodiment, similar to user device 800, described herein with respect to FIG. 8.

A user device may additionally include internet-of-things devices, such as one or more of the following: a sensor, controller (e.g., a lighting controller, a thermostat), appliances (e.g., a smart refrigerator, a smart air conditioner, a smart alarm system), other internet-of-things devices, or one or more combinations thereof. Internet-of-things devices may be stationary, mobile, or both. In some aspects, the user device is associated with a vehicle (e.g., a video system in a car capable of receiving media content stored by a media device in a house when coupled to the media device via a local area network). In some aspects, the user device comprises a medical device, a location monitor, a clock, other wireless communication devices, or one or more combinations thereof.

In aspects, a user device discussed herein may be configured to communicate using one or more of 3G, 4G (e.g., LTE), 5G, 6G, another generation communication system, or one or more combinations thereof. In some aspects, the user device has a radio that connects with a 4G base station but is not capable of connecting with a higher generation communication system. In some aspects, the user device has components to establish a 5G connection with a 5G gNB, and to be served according to 5G over that connection. In some aspects, the user device may be an E-UTRAN New Radio-Dual Connectivity (ENDC) device. ENDC allows a user device to connect to an LTE eNB that acts as a master node and a 5G gNB that acts as a secondary node. As such, in these aspects, the ENDC device may access both LTE and 5G simultaneously, and in some cases, on the same spectrum band.

“Wireless telecommunication services” refer to the transfer of information without the use of an electrical conductor as the transferring medium. Wireless telecommunication services may be provided by one or more telecommunication network providers. Wireless telecommunication services may include, but are not limited to, the transfer of information via radio waves (e.g., Bluetooth®), satellite communication, infrared communication, microwave communication, Wi-Fi, mmWave communication, and mobile communication. Embodiments of the present technology may be used with different wireless telecommunication technologies or standards, including, but not limited to, CDMA 1×Advanced, GPRS, Ev-DO, TDMA, GSM, WiMax technology, LTE, LTE Advanced, other technologies and standards, or one or more combinations thereof.

A “network” providing the wireless telecommunication services may be a telecommunication network(s), or a portion thereof. A telecommunication network might include an array of devices or components (e.g., one or more base stations). The network can include multiple networks, and the network can be a network of networks. In embodiments, the network is a core network, such as an evolved packet core, which may include at least one mobility management entity, at least one serving gateway, and at least one Packet Data Network gateway. The mobility management entity may manage non-access stratum (e.g., control plane) functions such as mobility, authentication, and bearer management for other devices associated with the evolved packet core.

In some aspects, a network can connect one or more user devices to a corresponding immediate service provider for services such as 5G and LTE, for example. In aspects, the network provides wireless telecommunication services comprising one or more of a voice service, a message service (e.g., SMS messages, MMS messages, instant messaging messages, an EMS service messages), a data service, other types of wireless telecommunication services, or one or more combinations thereof, to user devices or corresponding users that are registered or subscribed to a telecommunication service provider to utilize the one or more services. The network can comprise any communication network providing voice, message, or data service(s), such as, for example, a 1× circuit voice, a 3G network (e.g., CDMA, CDMA2000, WCDMA, GSM, UMTS), a 4G network (WiMAX, LTE, HSDPA), a 5G network, a 6G network, another generation network, or one or more combinations thereof.

Components of the network, such as terminals, links, and nodes (as well as other components), can provide connectivity in various implementations. For example, components of the network may include core network nodes, relay devices, integrated access and backhaul nodes, macro eNBs, small cell eNBs, gNBs, relay base stations, other network components, or one or more combinations thereof. The network may interface with one or more base stations through one or more wired or wireless backhauls. As such, the one or more base stations may communicate to devices via the network or directly. Furthermore, user devices can utilize the network to communicate with other devices (e.g., a user device(s), a server(s), etc.) through the one or more base stations.

As used herein, the term “base station” (used for providing UEs with access to the telecommunication services) or “node” generally refers to one or more base stations, nodes, RRUs control components, and the like (configured to provide a wireless interface between a wired network and a wirelessly connected user device). A base station may comprise one or more nodes (e.g., eNB, gNB, and the like) that are configured to communicate with user devices. In some aspects, the base station may include one or more band pass filters, radios, antenna arrays, power amplifiers, transmitters/receivers, digital signal processors, control electronics, GPS equipment, and the like.

For example, the base station may refer to a base transceiver station, a radio base station, an access point, a radio transceiver, a NodeB, an eNB, a gNB, a Home NodeB, a Home eNodeB, another type base station, or one or more combinations thereof. A node corresponding to the base station may comprise one or more of a macro base station, a small cell or femtocell base station, a relay base station, another type of base station, or one or more combinations thereof. In aspects, the base station may be configured as FD-MIMO, massive MIMO, MU-MIMO, cooperative MIMO, 3G, 4G, 5G, another generation communication system, or one or more combinations thereof. In addition, the base station may operate in an extremely high frequency region of the spectrum (e.g., from 30 GHz to 300 GHz), also known as the millimeter band.

Aspects of the technology described herein may be embodied as, among other things, a method, system, or computer-program product. Accordingly, aspects may take the form of a hardware embodiment, or an aspect combining software and hardware. An aspect that takes the form of a computer-program product can include computer-useable instructions embodied on one or more computer-readable media.

Computer-readable media include both volatile and nonvolatile media, removable and nonremovable media, and contemplate media readable by a database, a switch, and various other network devices. Network switches, routers, and related components are conventional in nature, as are means of communicating with the same. By way of example, and not limitation, computer-readable media comprise computer-storage media and communications media.

Computer-storage media, or machine-readable media, include media implemented in any method or technology for storing information. Examples of stored information include computer-useable instructions, data structures, program modules, and other data representations. Computer-storage media include, but are not limited to RAM, ROM, EEPROM, flash memory or other memory technology, CD-ROM, digital versatile discs (DVD), holographic media or other optical disc storage, magnetic cassettes, magnetic tape, magnetic disk storage, and other magnetic storage devices. These memory components can store data momentarily, temporarily, or permanently.

Communications media typically store computer-useable instructions—including data structures and program modules—in a modulated data signal (e.g., a modulated data signal referring to a propagated signal that has one or more of its characteristics set or changed to encode information in the signal). Communications media include any information-delivery media. By way of example but not limitation, communications media include wired media, such as a wired network or direct-wired connection, and wireless media such as acoustic, infrared, radio, microwave, spread-spectrum, and other wireless media technologies. Combinations of the above are included within the scope of computer-readable media.

By way of background, an FWA device is a type of wireless communication technology that provides broadband internet access to fixed locations, such as homes, offices, and other buildings. Unlike traditional wired broadband services (e.g., DSL, cable, or fiber), the FWA device uses wireless radio links to connect end-users to the internet. This technology is particularly beneficial in rural or remote areas where laying down wired infrastructure is challenging and costly. The evolution of the FWA device technology has been driven by advances in wireless communication standards, including 4G LTE and, more recently, 5G. The transition to 5G networks has been a significant leap forward, offering upload and download speeds rivaling or surpassing traditional home internet services, such as cable or fiber, (“Landline Service”). However, the quality of the internet services users receive from the wireless provider may be affected by a poor connection between the FWA device and a base station, limiting user satisfaction.

Conventionally, a wireless service provider may provide an indication of a received signal strength on the FWA device itself. This provides a suggestion to the user of where to place the FWA device to obtain the best signal strength, but not necessarily the best quality service, and thus user experience. Service providers have realized that the received signal strength alone is not enough to predict the quality of service and have encouraged users to use tools such as Ookla® by Ookla, LLC, and iPerf and iPerf3, on their own user-equipment (“UE”) connected to the FWA device. This solution is limited by the connection between the UE and the FWA device, which can provide erroneous information to the user about the signal quality between the FWA device and a base station.

Unlike conventional solutions, the present disclosure addresses these challenges head-on by incorporating a multi-tiered strategy. This approach provides accurate information to the user regarding the performance of the FWA device to base station connection (“device performance”). By measuring the device performance in multiple locations at a user's location, the best placement location may be determined. A machine learning module, also known as artificial intelligence (“AI”), provides recommendations on device placement, based on the particular user's location. By implementing an optimized packet scheduler to prioritize particular devices or types of devices connected to the FWA device, the FWA device may be further optimized for user satisfaction.

An FWA system primarily comprises two components: the base station (or access point) and the fixed wireless access device (also known as Customer Premises Equipment, CPE, or FWA device). The base station is a central node that transmits and receives wireless signals to and from multiple FWA devices. It is connected to the core network and the internet backbone. The FWA device is installed at the user's premises. It communicates wirelessly with the base station to provide internet connectivity to the end-user devices, such as computers, smartphones, smart TVs, and other internet-enabled devices within the premises.

The FWA device serves as the intermediary between the user's internal network and the base station. It receives data from the base station and transmits it to the user's devices and vice versa. For optimal performance, FWA devices are usually installed in locations with clear line-of-sight to the base station, such as rooftops or external walls.

FWA devices (e.g., High Speed Internet (HINT) Devices) play a crucial role in the delivery of high-speed internet to fixed locations, especially in areas lacking traditional broadband infrastructure. The continuous exchange of detailed operational data between FWA devices and the base station ensures robust, reliable, and high-performance internet connectivity, thereby enhancing the overall user experience. As FWA technology continues to evolve, the integration of advanced data analytics and AI-driven network management will further optimize the performance and reliability of FWA systems.

Various components may be involved in FWA systems. For exemplary purposes only, some of these components may include a base station that acts as the central hub connected to the internet backbone, and is equipped with antennas to transmit and receive signals over a wide area. The FWA device itself may be installed at the user's premises (home, office, etc.), and it may communicates wirelessly with the base station. Further, the FWA device connects to internal devices through wired (Ethernet) or wireless (Wi-Fi) connections.

The operational workflow for FWA devices includes signal transmission from the base station to the FWA device. The base station emits radio signals that cover a defined service area. These signals carry data to and from the internet. The FWA device, equipped with an antenna, receives these radio signals. Optimal placement of the FWA device is crucial, often requiring line-of-sight to the base station to minimize signal obstruction and interference. The received signals are processed by the FWA device, converting the radio waves into digital data. This involves demodulation, error correction, and data decoding to ensure accurate and efficient data transfer. The processed data is distributed to internal devices (e.g., computers, smartphones, smart TVs) within the user's premises. This distribution can occur via Wi-Fi or Ethernet. For Wi-Fi distribution, the wireless signals within the premises allow mobile and stationary devices to connect without cables. For Ethernet, there are wired connections to devices that support or require stable, high-speed internet access. When a user device requests data (e.g., browsing the internet, streaming video), the FWA device aggregates this data and transmits it back to the base station. The FWA device modulates and encodes the data into radio signals suitable for transmission. The base station receives the data from the FWA device, processes it, and routes it to the appropriate destination on the internet. Responses from the internet are similarly processed and sent back to the FWA device, completing the data exchange cycle.

Modern FWA devices often use advanced antenna technologies, such as Multiple Input Multiple Output (MIMO) and beamforming, to enhance signal strength, range, and reliability. Moreover, FWA devices operate in licensed and unlicensed frequency bands, including sub-6 GHz and millimeter-wave (mmWave) frequencies. The choice of frequency band affects coverage, bandwidth, and penetration capabilities. FWA systems may implement QoS mechanisms to prioritize critical traffic, manage bandwidth allocation, and ensure consistent performance for various applications (e.g., video conferencing, online gaming). Data encryption and secure communication protocols protect user data from interception and unauthorized access. FWA devices can be remotely monitored and updated by service providers, ensuring they run the latest firmware and configuration settings for optimal performance and security.

In an exemplary implementation, consider an FWA device serving a residential area with multiple homes. Each home may have several devices to be connected to the FWA device, such as smartphones, laptops, smart TVs, and IoT devices. The method would proceed as follows: The FWA device connects to the base station, which operates a first network, typically a telecommunications network, for example 3G, 4G, 5G, 6G, LTE, or any type of network. The FWA device determines its location, which may be determined by being received from the base station, triangulation of network elements, or a global positioning system device (GPS or similar). The FWA device receives network data and map data from the base station or from onboard storage. The FWA device then determines at least one performance parameter, which is used to calculate a connection quality. The FWA device requests at least one site parameter, such as number of stories or window locations and incorporates the responses into the network data. The FWA device then predicts a second connection quality for a second location based on the at least performance parameter, the network data, and the map data. If the FWA device determines the predicted second connection quality is greater than the first connection quality, the FWA device displays a representation of the first location and second location, which may include the connection quality and predicted connection quality.

There are many advantages to the aspects provided herein, for example being able to guide a user in placing an FWA device within a user site or premise. Further, aspects enable additional information other than signal strength to be used in guiding a user in placing the FWA device. Another advantage is integrating unique home site location data which can be incorporated with the network data to greatly improve the connection quality or accurately determine atypical results. By accurately determining the placement location of an FWA device, the connection quality may be optimized and the time to obtain such an improvement may be reduced, thus creating an enhanced user experience when aspects described herein are utilized.

In a first aspect, a system is provided for facilitating placement of a fixed wireless access (FWA) device. The system includes an FWA device comprising one or more antennas for receiving a downlink signal from a serving cell and for transmitting an uplink signal to the serving cell, the FWA device further comprising a processor. The system further includes computer memory storing computer-usable instructions that, when executed by the one or more processors, perform operations. These operations comprise, at the FWA device, determining values for a set of parameters for a plurality of placement locations, where the set of parameters comprises a downlink signal speed, an uplink signal speed, and a current location associated with the FWA device. The operations further comprise generating a recommended placement location for the FWA device based on at least the values for the set of parameters for the plurality of placement locations.

In a second aspect, a method is provided for improving performance of an FWA device. The method includes, at the FWA device, connecting to a first network, determining the first location of the FWA device, receiving network and map data, determining at least one performance parameter of a connection between the FWA device and the first network, calculating a first connection quality based on the at least one performance parameter at the first location, and predicting a second connection quality for a second location based on the at least one performance parameter, the network data, and the map data. The method further includes determining that the second connection quality is greater than the first connection quality, and displaying a representation of the first location and the second location.

In a third aspect, one or more non-transitory computer storage media having computer-executable instructions embodied thereon are provided, that when executed by at least one processor, cause the at least one processor to perform a method. The method includes, at a first network, establishing a connection to an FWA device, determining a first location of the FWA device, retrieving network data and map data associated with the FWA device, determining at least one performance parameter of a connection between the FWA device and the first network, and calculating a first connection quality based on the at least one performance parameter at the first location. The method further includes predicting a second connection quality for a second location based on the at least one performance parameter, the network data, and the map data, determining that the second connection quality is greater than the first connection quality, and transmitting for display a representation of the first location and the second location

FIG. 1 illustrates an example of a network environment 100 suitable for use in implementing embodiments of the present disclosure. The network environment 100 is but one example of a suitable network environment and is not intended to suggest any limitation as to the scope of use or functionality of the disclosure. Neither should the network environment 100 be interpreted as having any dependency or requirement to any one or combination of components illustrated.

More specifically, FIG. 1 depicts a system for facilitating efficient resource allocation for devices served by an FWA device within a wireless telecommunications network. The system includes components and interactions between the FWA device and a network node to determine the number of connected devices, gather device-specific information, and communicate this information to optimize resource management. Network environment 100 includes node 102 (e.g., base station), an FWA device 106, and user devices 108, 110, and 112. The FWA device 106, and user devices 108, 110, and 112 may be located at a user's premise (“user site 120”).

As mentioned, network environment 100 includes user devices 108, 110, and 112. In network environment 100, user devices 108, 110, and 112 may take on multiple forms, such as cameras, microphones, sensors, goggles, and glasses, to name a few, or any other device (such as the user device (800)) that communicates via wireless communications with the FWA device 106 in order to interact with a public or private network.

In some aspects, each of the user devices 108, 110, and 112 may correspond to user device 800 in FIG. 8. Thus, the user device can include, for example, a display(s), a power source(s) (e.g., a battery), a data store(s), a speaker(s), memory, a buffer(s), a radio(s) and the like. In some implementations, for example, user devices 108, 110, and 112 comprise a wireless or mobile device with which a wireless telecommunication network(s) can be utilized for communication (e.g., voice and/or data communication). In this regard, the user devices 108, 110, and 112 can be any mobile computing device that communicates by way of a wireless network, for example, a 3G, 4G, 5G, 6G, LTE, CDMA, or any other type of network. In some cases, user devices 108, 110, and 112 in network environment 100 can optionally utilize one or more communication channels (not shown) to communicate with other computing devices (e.g., a mobile device(s), a server(s), a personal computer(s), etc.) through the FWA device 106 and node 102. Node 102 may be a gNodeB, eNodeB, or the like.

The network environment 100 may be comprised of a telecommunications network(s) (now shown), or a portion thereof. A telecommunications network might include an array of devices or components (e.g., one or more base stations), some of which are not shown. Those devices or components may form network environments similar to what is shown in FIG. 1, and may also perform methods in accordance with the present disclosure. Components such as terminals, links, and nodes (as well as other components) can provide connectivity in various implementations. Network environment 100 can include multiple networks, as well as being a network of networks, but is shown in more simple form so as to not obscure other aspects of the present disclosure.

Communication channel 104 can be part of a telecommunication network that connects subscribers to their immediate telecommunications service provider (i.e., home network carrier). In some instances, such as when an FWA device is utilized, the communication channels are associated with a telecommunications provider that provides services (e.g., 3G network, 4G network, LTE network, 5G network, 6G network, and the like) to the FWA device, such as the FWA device 106. For example, the communication channels may provide voice, SMS, and/or data services to user devices 108, 110, and 112 through the FWA device 106, or corresponding users that are registered or subscribed to utilize the services provided by the telecommunications service provider. Some devices, such as user devices 108, 110, and 112, connect to the FWA device 106 and receive telecommunications services through this device. The communication channels can comprise, for example, a 1× circuit voice, a 3G network (e.g., CDMA, CDMA2000, WCDMA, GSM, UMTS), a 4G network (WiMAX, LTE, HSDPA), a 5G network or a 6G network.

In some implementations, node 102 is configured to communicate with user devices 108, 110, and 112 by way of the FWA device 106, which may be located in a same area as the user devices 108, 110, and 112, referred to as the user site 120. As such, radio antennas of node 102 may send communications to the FWA device 106, which then serves user devices 108, 110, and 112. Node 102 may include one or more base stations, base transmitter stations, radios, antennas, antenna arrays, power amplifiers, transmitters/receivers, digital signal processors, control electronics, GPS equipment, and the like.

The FWA device 106 provides device connectivity to the wireless network to user devices 108, 110, and 112 by way of, for example, communication links 114, 116, and 118. The FWA device 106 serves multiple end-user devices within a specific coverage area, providing broadband wireless connectivity. This device is equipped with components to determine the number of connected devices, request information from them, and communicate with node 102. In some aspects, the connection quality of communication channel 104 may impact the connection quality of the user devices 108, 110, and 112 by way of, for example, communication links 114, 116, and 118. In some aspects, the connection quality of communication channel 104 may affected by a number of factors including; the distance to node 102, geographic or terrain elements between node 102 and FWA device 106, urban or structure build up between node 102 and FWA device 106, the type of communications provided by node 102, and the number of other user devices connected to node 102. The placement of FWA device 106 within the user site 120 may have eliminate or mitigate the factors which impact the connection quality of the communication channel 104.

In another aspect, the FWA device 106 may assign each of the user devices or user-equipment devices (UEs) a category to prioritize network resources to the UEs based on the category. An FWA system may implement a packet scheduler to deliver user traffic on an uplink channel back to the base station connection, and downlink traffic from the base station to the user equipment. By implementing an optimized packet scheduler, prioritization of uplink/downlink packets to particular devices or types of devices connected to the FWA device, can be used to optimize user performance satisfaction of near-real-time performance demands over less time sensitive packet deliverables. The FWA device may be further optimized for user satisfaction by prioritizing one type of user data over another type of user data all flowing through the same FWA. For example, the categories may prioritize minimizing latency, and therefore devices may be categorized based on their sensitivity to latency, where gaming and streaming devices are highly impacted. The attached UEs may be categorized by at least two different categories and prioritized accordingly. In other embodiments, total data throughput may be a priority for some devices and not others, allowing the creation of a least one category to emphasize download speeds and one category that does not. The UEs may by assigned multiple categories and the categories may emphasize different network resources. The user(s) may determine or modify which UEs are assigned to a particular category.

In some aspects, the FWA device 106 may also comprise a secondary power source or an on-device energy storage element, such as a battery. The on-device energy storage element may allow a user to change placement locations of the FWA device 106 while determining an optimum placement location. In one embodiment, the FWA device 106 may determine that the power has been disconnected and enter into a lower power mode relying on the on-device energy storage element. In one aspect, the FWA may use the optimized packet scheduler to assign UEs to different priority categories such that during the lower power mode, some categories may be disconnected to preserve power, others may be limited in network resource use, while other may have full network usage.

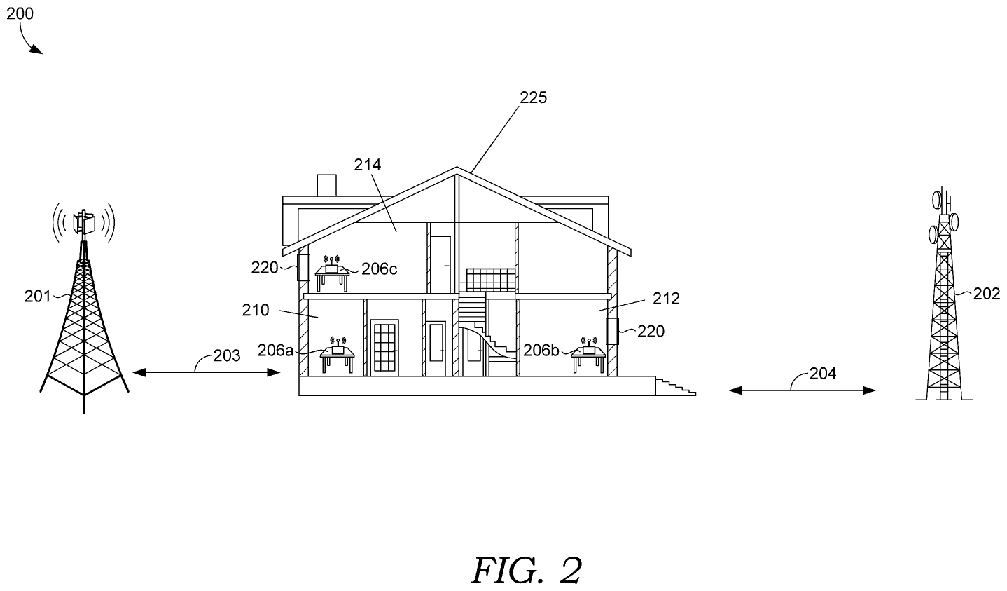

Turning to FIG. 2 which illustrates an example operating environment 200 for an FWA device, such as FWA device 106 as described in FIG. 1, connected to a wireless network while facilitating optimum placement locations at a user site 225. The user site 225 may be the same or substantially similar to user site 120 described earlier. For ease of understanding, the user site 225 is depicted as a two story home, however the user site 225 may comprise one of a variety of structures such as, residential, business, government, commercial, or industrial facility with any number of floors or configurations. In some aspects, the FWA device 106 may have a first location of 206a in a first room 210. In the first location 206a, the FWA device 106 may connect to a network via node 201 in a manner as described in FIG. 1, forming communication channel 203. A connection quality may be determined for the communication channel 203, this can be performed at the node 201, the FWA device 106, a remote server on the network, or another device. The connection quality may be determined by using at least one performance parameter such as; signal strength from the node 201, downlink speed, uplink speed, latency, or detected interferences. The connection quality may be represented by a single performance parameter, a combination of parameters, or a relative value based on one or more of the parameters. In some embodiments, the relative value may be represented as a scaled score such as a number between 1 to 5 or 1 to 10 or 1 to 100. The relative value may also be or include a text or verbal indication of predicted value such as; ‘poor,’ ‘fair,’ ‘good,’ ‘great,’ and ‘excellent.’ Other terms or fewer terms may be used to describe to the relative value. The signal quality may also be color coded based on a relative value, such as red for poor, yellow for good, and green for excellent.

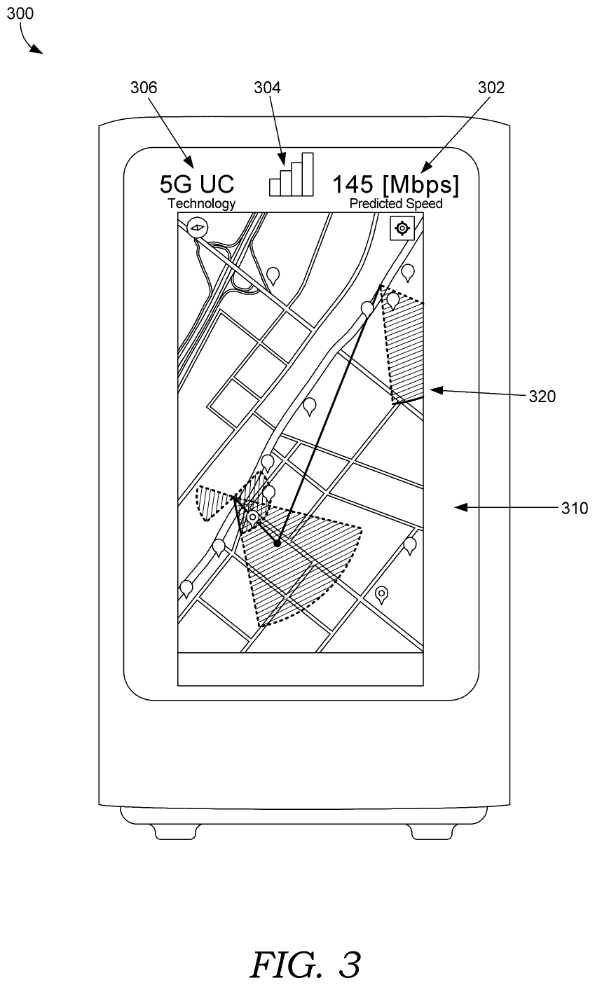

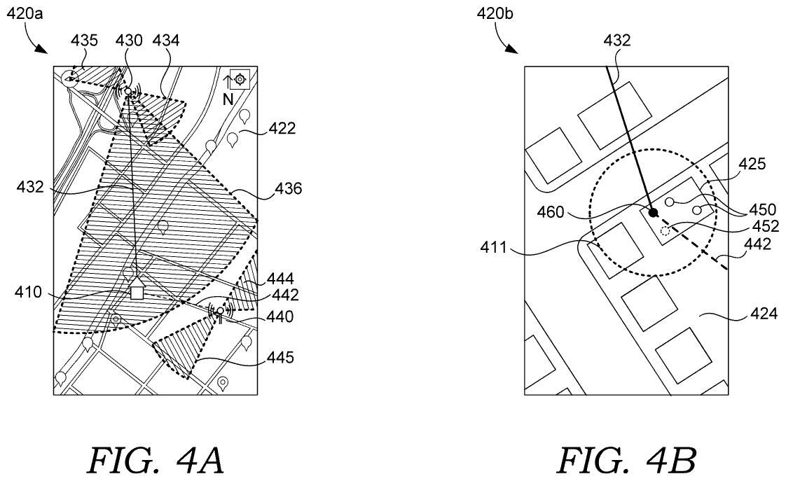

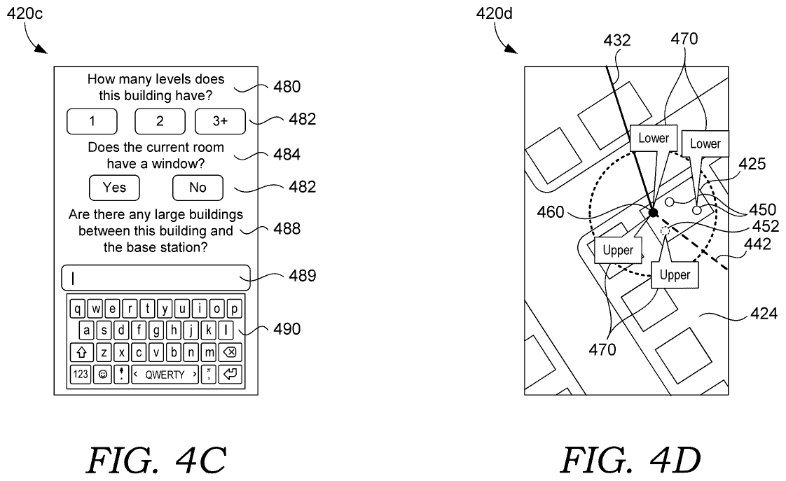

In addition to the connection quality, a predicted connection quality for a second location may be calculated, based on the at least one performance parameter used in calculating the connection quality, the network data, and the map data. The network data may include location of nearby nodes or cells, cell data, cell connection type, cell availability, cell capacity, cell load, maximum download speeds from a cell, availability of beam forming, and other characteristics of wireless telecommunications. The map data may comprise geographical features, 3D structure data, information about the user site 225, locations of other devices connected to the network, known areas with poor connectivity from one or more cells, the position of nodes and cells, and other information which could impact connection quality. In some embodiments, the connection quality and the predicted connection quality may be represented by the same parameter(s), combination of parameters, or relative value. The connection quality may compared to the predicted connection quality at the second location. The second location may be suggested if the predicted connection quality is greater than the connection quality by a pre-determined threshold. The second location may be suggested to the user in a manner as described herein in FIGS. 3-4D. In some aspects, instructions may be provided to the user device prior to or during an initial set up and connection to node 201. After communication channel 203 is established, it may be determined that the connection quality of the communication channel 203 at the first location 206a is less than the predicted connection quality. As such, the user may be provided the second location as a suggestion or recommendation.

In some aspects, the FWA device 106 may be moved to the second location 206b in a second room 212, which may be proximate to a window 220. The FWA device 106 may receive indication that the signal strength from a second node 202 is strong at the second location 206b. The FWA device 106 may connect to the second node 202 and form a second communication channel 204 to the network. In further aspects, a second connection quality may be determined for the second location 206b as described above, for the first location 206a. It may be determined, although one or more of the performance parameters may be good, the second connection quality is not ideal. For example, the second node 202 may provide network services using a different or older telecommunications technology than node 201, such as LTE at the second node 202 versus 5G or 5G mmWave at the node 201. Alternatively, the second node 202 may be connected to a number of other user devices greater than the capacity of the second node 202 or serving cell of the second node 202. Further, a predicted connection quality for a third location may be calculated. The predicted connection quality for the third location may be compared to the connection quality at the second location 206b and/or the connection quality at the first location 206a to determine if the third location should be suggested to the user. Should it be determined that the predicted connection quality for the third location is a sufficient improvement over the prior connection qualities, the third location may be suggested to the user.

In one aspect, the FWA device 106 may be placed in a third room 214 at the third location 206c which may be near another window 220. The FWA device 106 may reconnect to the node 201 and form the second communication channel 204 to the network. The room 214 is illustrated as being a second story room, the third location 206c may have better line of sight with the node 201 or may not have interference caused by other electronic devices. Rooms 210, 212, and 214 may depict different locations in one or more rooms and are not limited to being different rooms in the typical sense. In further aspects, a third connection quality may be determined for the third location 206c in the manner as described previously. Once again, a predicted connection quality for a fourth location may be calculated in the manner as previously described. The predicted connection quality for the fourth location may be compared to the determined connection quality values for the first, second, and third locations, respectively numbered 206a, 206b, 206c. It may be determined that the third connection quality is within a threshold of the predicted connection quality for the fourth location. The third connection quality may exceed the predicted connection quality for the fourth location. The fourth location may not be provided to the user and/or a notification to the user indicating that the third location 206c is operating within expected parameters may be provided. In one aspect, this placement process may be limited to a number of attempts or locations. In another aspect, the threshold between predicted connection quality and determined connection quality may decrease after every placement. The number of placement attempts may be limited by providing relevant information and instructions to the user and/or receiving input from the user.

In another aspect, to prevent a node from being overburdened by unexpected FWA devices in an area, the network, node, and/or the FWA device 106 may implement a procedure to prevent this overloading. Prior to the connection process, the network may assign the FWA device 106 a registration area based on the user's expressed user site 225. During registration, the network may ensure there is at least one node capable of serving the registered area without over burdening the network or the local nodes. During the initial setup, after the FWA device 106 connects to the node 201 and the FWA device 106 location is determined, the node 201, network, or the FWA device 106 may verify that the FWA device 106 is located within the registration area. In one embodiment, should the FWA device 106 be determined to be outside of the registration area, a notification would be provided indicating the user to contact customer support or re-register their home location. In another embodiment, the FWA device 106 may be registered at the new location only if resources permit registration. In other aspects, if the FWA device 106 is in the registration area assigned to the FWA device 106, the placement location process may continue.

Turning to FIG. 3, which illustrates an example FWA device while facilitating determination of an optimum placement location 300 at a user site. The FWA device while facilitating determination of an optimum placement location 300 may represent the FWA device 106 from a first side (or 206). In one aspect, the FWA device may have a display 310. The display 310 may be one or more displays. In some aspects, the display may comprise at least an LED (light emitting diode) screen, OLED (organic LED), e-ink, or similar display technologies in use on small electronic devices. In other aspects, the plurality of displays may also include static displays such as printed labels, diodes, liquid crystal displays, and similar technology. The display 310 may be configured to display a connection quality indicator 302, a signal strength indicator 304, a technology indicator 306, and a graphic element. The display 310 may comprise a graphic display 320, which may be capable of displaying color and detailed graphics (such as in a map). The graphic display 320 may have interactive capabilities such as touch screen or physical buttons to allow interaction from the user. The graphic display 320 may be configured to display the connection quality indicator 302, the signal strength indicator 304, and the technology indicator 306.

In some aspects, the connection quality indicator 302 may display one or more of a quality for the determined connection quality for the communication channel 203, the predicted connection quality for a suggested location, or past connection quality. As described herein, the connection quality may be represented by one or more performance parameters or by a relative value. In some embodiments, the connection quality may display one or more performance parameters, but also provide a visual indication of the relative quality of that metric. The visual indication may be color coded from red to green or may include a bar or other graphic indication of relative connection quality. In one aspect, the connection quality may display a performance parameter and a text indication as to the quality of the metric or quality of other metrics not presented to the user. For example, in FIG. 3, connection quality indicator 302 is illustrated displaying a predicted speed of 145 [Mbps], however the connection quality may indicate a speed that is much lower (such as 20 [Mbps]), and therefore may display the predicted speed in a red color. The connection quality indicator 302 may also represent a visual indication of the connection quality performance compared to the predicted connection quality. As discussed previously, a relative value for connection quality and predicted connection quality may be displayed in a text format such as; ‘poor,’ ‘fair,’ ‘good,’ ‘great,’ and ‘excellent.’ Other terms or fewer terms may be suitable to describe the relative value.

In some aspects, the signal strength indicator 304 may be an indicator of signal strength as employed commonly in the telecommunications field (e.g. a series of bars with progressive heights). In some embodiments, signal strength indicator 304 may display a numerical value for signal strength, such as those used with a received signal strength indicator (RSSI), which displays a relative value. In other embodiments, the signal strength may be displayed in a text format such as; ‘poor,’ ‘fair,’ ‘good,’ ‘great,’ and ‘excellent.’ Other terms or fewer terms may be suitable to describe to the relative value. The signal strength indicator 304 may be color coded based on relative performance or expected performance. In other aspects, the technology indicator 306 may display text representing which type of technology is being used to form a communication channel 203 with the node 201, such as “LTE,” “5G,” “5G UC,” or “6G.” In other embodiments, the signal strength may be displayed in a text format such as; ‘good,’ ‘better,’ and ‘best.’ The technology indicator 306 may indicate the technology employed by any means known in the art to indicate a discrete value. The technology indicator 306 may be color coded based on relative performance or expected performance as well. The connection quality indicator 302, the signal strength indicator 304, and the technology indicator 306 may be placed anywhere on the display 310. In some aspects, one or more of the signal strength indicator 304 or the technology indicator 306 may not be displayed unless the FWA device is facilitating optimum placement location.

Lastly, the graphic display 320, which may be configured to display a map, speed tests, user site information, notifications, and more, as described herein in FIGS. 4A-4D. As illustrated in FIG. 3, graphic display 320 displays a map of an area around the FWA device 206 at the user site 225, including network features such as nodes, cell coverage areas, and map features, such as streets and highways. The information presented on the graphic display 320 may be dynamic or may change to communicate specific information to the user. Some aspects of the graphic display 320 are described further in FIGS. 4A-4C.

Turning now to FIGS. 4A-4D, these figures illustrate various aspects of a graphic display 320 for an FWA device 106 for determining optimal placement location of the FWA device at a user site 225. Starting with FIG. 4A, FIG. 4A illustrates an embodiment of the graphic display 320 depicting a first screen 420a presenting details of an area around the user site 225. The user site 225 may not be centered on the first screen 420a. The first screen 420a may include an area map 422, which may be a road map, a topical map, a geographic map, or a three-dimensional (3D) map of any combination thereof. The FWA device 106 may obtain this map information from a remote server on the network, node 201, the map data may be stored inside the memory of the FWA device 106, or the map data may be retrieved from a map service, such as Google Maps® or Bing Maps®. As illustrated, the area map 422 is a two-dimensional street map, but this is not a limiting example. In some embodiments the FWA device 106 or the user site 225 may be identified on the area map 422 by depicting a user site icon 410 on the position of the FWA device 106 relative to the area map 422. The position of the FWA device 106 or the user site 225 may be determined by global position service data, positioning from cellular towers, or be a registered address for the user site 225. In some embodiments, the area map 422 may contain a legend or labels to nearby points of interest to orient the user. The first screen 420a may include an overlay of the network data. The node 201 may be represented by a first node icon 430, while cell coverage areas of the first node may be represented by shaded or outlined areas 435, 434, 436. The second node 202 may be represented by a second node icon 440, while cell coverage areas of the first node may be represented by shaded or outlined areas 445 and 444. The communications channels, such as the communication channel 203 and the second communication channel 204 as described in FIG. 2, may be represented by lines 432, 442 respectively, between the node icons 430, 440 and the user site icon 410. An active communications channel may be marked with a solid line 432 and a potential communications channel may be marked with a dashed line, such as line 442. The information on the first screen 420a may be displayed before the second location is suggested or before a communications channel is established.

The first screen 420a in FIG. 4A provides an area map 422 to facilitate placing the FWA device 106 and may provide additional context later as the user receives recommended locations. Moving to FIG. 4B, a second screen 420b provides a local map 424 that enables the user to see more details of their user site. In some embodiments, a user site location ring 411 may indicate an approximate range of a second telecommunications network transmitted from the FWA device 106, such as WiFi network. In some aspects, the FWA device 106 may be determined to be located within a structure 425, which may or may not be indicated on the second screen 420b. In some embodiments, the current location of the FWA device 106 may be indicated by a current location icon 452. In some aspects, the second screen 420b may initially populate with the local map 424 and the current location icon 452. During a connection process between the FWA device 106 and the network, the second screen may be updated with a solid line 432 representing communication channel 203 and possibly dashed line(s) 442 representing potential communication channels. After connecting to the node 201, if it is determined that a second proposed location would likely offer a better connection quality, as described in FIG. 2, (by a predicted connection quality at a second location) a suggested placement location 460 for the FWA device 106 may be displayed on the second screen 420b. After the FWA device 106 is placed at the suggested placement location 460, the second screen 420b may update to reflect the location 452 as being where the suggested placement location 460 was located, while the previous location may be represented by a tested location icon 450. In some embodiments, the second screen 420b may display one or more tested location icons 450. The tested location icons 450 may be limited in number on the second screen 420b, such limitations may show a number of the most recently tested locations or in other embodiments may only show a number of the previous locations with the best connection quality. The tested location icons 450 may contain additional information such as an indication of connection quality, a ranking, or an order in which they were placed. This may also be done by a color gradient as well.

Turning to FIG. 4C, an additional embodiment is illustrated of the graphic display 320 for an FWA device 106 while facilitating determination of an optimum placement location at a user site 225. In this embedment, a third screen 420c may by interactive with a user by displaying one or more questions or prompts for the user. In some embodiments, the graphic display 320 may have been configured to receive touch inputs (touch events). In other embodiments the FWA device 106 is configured to receive audio inputs or in another configuration have at least one button to receive inputs from a user, including one or more buttons. In one embodiment, a preliminary interaction 480 may be presented prior to the placement process. A user response prompt 482 may provide a plurality of options or inputs for the user to select from. In some embodiments a received input from the user response prompt 482 may trigger additional preliminary interactions 480, instructions, or notifications. In another aspect, third screen 420c may provide an after placement interaction 484, which may provide crucial information in determining a predicted connection quality at a future location. The after placement interaction 484 may be a follow up question to interaction 480, 484, a notification or an instruction to the user. In some aspects, the interaction 480, 484 may be prompted during a placement process or may be provided only if certain performance parameters indicate the use of a particular interaction 480,484. For example, if the signal strength is below a pre-determined threshold or below a proportion of a predicted signal strength during the initial set up, the third screen 420c may prompt the user with questions regarding the number of floors/levels or window location.

In other aspects, a machine learning module may be used to generate interactions 480, 484 based on one or more of the performance parameters, map data, and network data. In some examples, the machine learning module may allow for freeform or narrative inputs from the user, therefore an input display 489 and keyboard 490 may be displayed on which the user may provide detailed or narrative responses. For example, the machine learning module may have already determined the position of the FWA device 106 should be adequate based on the available data, but the connection quality is below the predicted quality, and therefore prompt, “Are there any large buildings between this building and the base station?” to determine the reason for unacceptable connection quality. In other embodiments, the machine learning module may use the interactions 480, 484 to guide the user through the set up process. The machine learning module may also prompt the user to place the FWA device 106 in multiple corners on each floor of the user site 225 (North, South, East, West) to collect the necessary data to make a predicted signal quality for a suggested placement location 460. The machine learning module may provide multiple suggested placement locations 460 with an overall suggestion or a ranked list of other suitable locations, which would enable the user to balance needs of the FWA device 106 at the user site 225 with obtaining optimal connection quality for the FWA device 106.

Turning to FIG. 4D, FIG. 4D illustrates another embodiment of the graphic display 320 for an FWA device 106 while facilitating determination of an optimum placement location at a user site 225. In some aspects, the fourth screen 420d, may provide additional information to the user with the use of one or more informational callouts 470. As illustrated, the informational callouts 470 describe whether a placement location (previous, current, or suggested; 450, 452, 560) for the FWA device 106 is on an upper floor or a lower floor. In some embodiments, the informational callouts 470 may describe one or more of a performance parameter, a ranking of the connection quality, or the determined connection quality. The informational callouts 470 may also be color coded, for example red for poor connection quality and green for excellent connection quality.

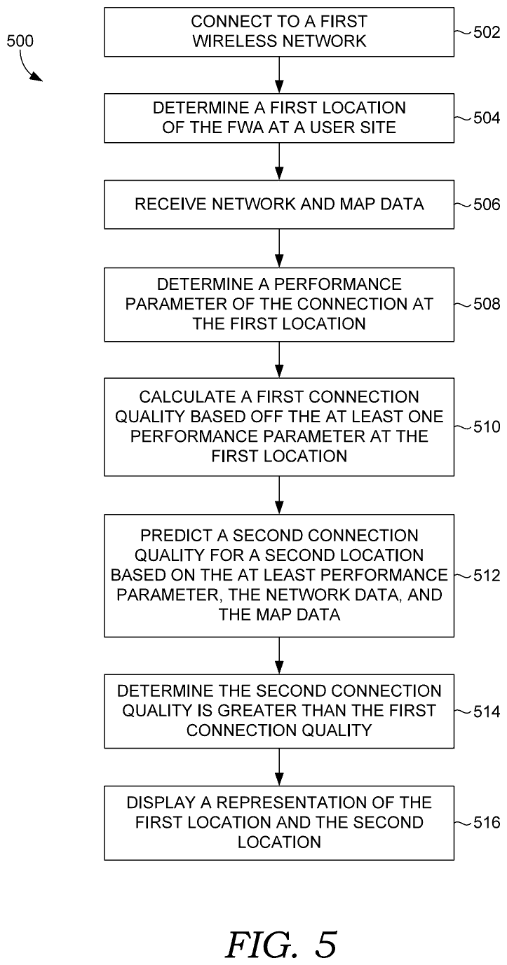

FIG. 5 illustrates an example flowchart of a method 500 for determining an optimal placement location of an FWA device at a user site. At block 502, the FWA device connects to a wireless network. In some aspects, the wireless network may be a telecommunications network such as LTE, 5G, 5G UC, 6G or similar. The connection to the network may be made through a first node. At block 504, a first location of the FWA device at the user site is determined. In some aspects, the location of the FWA device may be determined by a global positioning system, the wireless network or receipt of network signals, or may be determined by a pre-determined user site location. In some embodiments, the location of the FWA device is compared to a registration location, which may be a geo-fence location, and the process is disconnected if the FWA device is located outside of the registration location. In other embodiments, the first location may be determined through the use of an interactive map feature on the FWA device screen, where the FWA translates a touch event to coordinates that represent the location of the FWA device. At block 506, network data and map data are received. In some embodiments, the network and map data may be received by the FWA device, where the FWA device may determine the connection quality. In other aspects, the node or a server on the network receives the network data and the map data which will be used to determine connection quality. In some aspects, the server and the FWA device may receive the map and the network data. At block 508, at least one performance parameter of the connection between the FWA device and the network at the first location is determined. The at least one performance parameter may be a signal strength, a downlink speed, an uplink speed, a latency, or any another telecommunications performance parameter.

At block 510, a first connection quality is calculated based on a performance parameter. The connection quality may be represented by a single performance parameter such as downlink speed or may be a combination of parameters, such as downlink speed and signal strength, or a relative value determined by a combination of parameters. In some embodiments, the relative value may be represented as a scaled score such as a number between 1 to 5 or 1 to 10. The relative value may also be an indication of predicted value such as; ‘poor,’ ‘fair,’ ‘good,’ ‘great,’ and ‘excellent.’ At block 512, a second connection quality is predicted for a second location based off of at least the one performance parameter, the network data, and the map data. The prediction may be calculated at the FWA device, a remote server on the network, at the base station, or another device connected to the network or the FWA device. In some aspects, the second connection quality may be the same performance parameter, combination of parameters, or relative value for a combination of parameters used for the first connection quality. At block 514, the first connection quality is compared to the second connection quality and it is determined that the second connection quality is greater than the first connection quality. If the first connection quality is greater than the second connection quality, the process may conclude. At block 516, a representation of the first location and the second location are displayed. In some embodiments, the second location may be displayed with instructions and/or a predicted improvement. In other aspects, the first and second locations may be displayed on a map, which may contain a user site with sufficient detail to enable accurate placement of the FWA device.

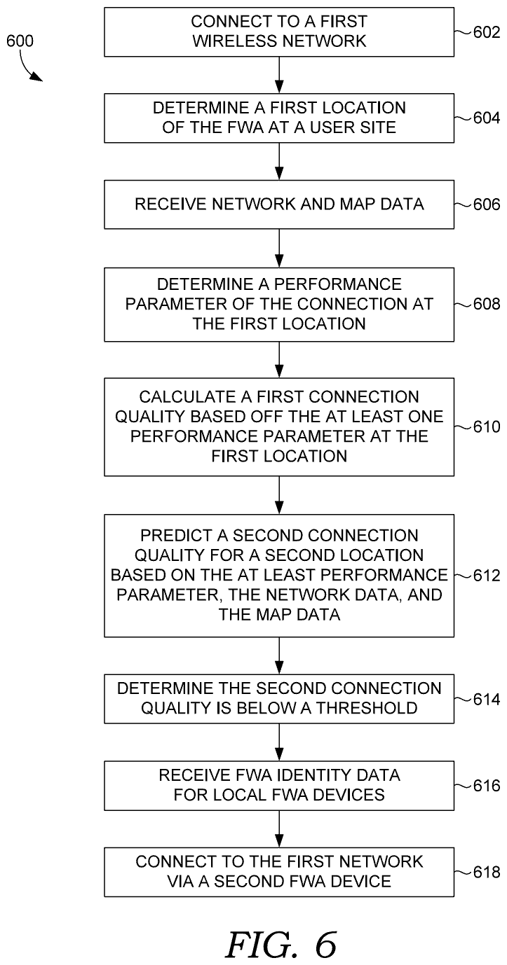

Turning to FIG. 6, an example flowchart is illustrated of a method 600 for determining an optimal placement location of an FWA device at a user site. At block 602, the FWA device connects to a wireless network. In some aspects, the wireless network may be a telecommunications network such as LTE, 5G, 5G UC, 6G or similar. The connection to the network may be made through a first node. At block 604, a first location of the FWA device at the user site is determined. As discussed in reference to FIG. 5, the location of the FWA device may be determined by a global positioning system, the wireless network or receipt of network signals, or may be determined by a pre-determined user site location. At block 606, network data and map data are received. In some embodiments, the network and map data may be received by the FWA device, where the FWA device may determine the connection quality. In other aspects, the node or a server on the network receives the network data and the map data, which will be used to determine connection quality. In some aspects, the server and the FWA device may receive the map and the network data. At block 608, at least one performance parameter of the connection between the FWA device and the network at the first location is determined. The at least one performance parameter may be a signal strength, a downlink speed, an uplink speed, a latency, or any another telecommunications performance parameter.

At block 610, a first connection quality is calculated based on the least the one performance parameter. The connection quality may be represented by a single performance parameter such as downlink speed or may be a combination of parameters, such as downlink speed and signal strength, or a relative value determined by a combination of parameters. In some embodiments, the relative value may be represented as a scaled score such as a number between 1 to 5 or 1 to 10. The relative value may also be an indication of predicted value such as; ‘poor,’ ‘fair,’ ‘good,’ ‘great,’ and ‘excellent.’ At block 612, a second connection quality is predicted for a second location based off of at least the one performance parameter, the network data, and the map data. The prediction may be calculated at the FWA device, a remote server on the network, at the base station, or another device connected to the network or the FWA device. In some aspects, the second connection quality may be the same performance parameter, combination of parameters, or relative value for a combination of parameters used for the first connection quality. At block 614, the second connection quality is determined to be below a threshold. In some embodiments, the threshold may be predetermined or may be determined based on the available network resources as provided in the network data or geographical information obtained in the map data. In other aspects, the threshold may be a predetermined level of quality to ensure a minimum level of quality to all users.

At block 616, identity data for local FWA devices is received. The identity data may be received at the FWA device, a remote server on the network, at the base station, or another device connected to the network or the FWA device. In some embodiments, the FWA device may disconnect from the first network after receiving the identity data of local FWA devices. At block 618, the FWA device connects to the first network by connecting to a second FWA device. In some aspects, the FWA device may connect to the second FWA device using the techniques In other aspects, the FWA device may select from one of the local FWA devices whose identity was provided in block 616. The FWA device may connect to the second FWA device through a telecommunications technology as described in block 602 or by another wireless technology such as WiFi or Bluetooth®.

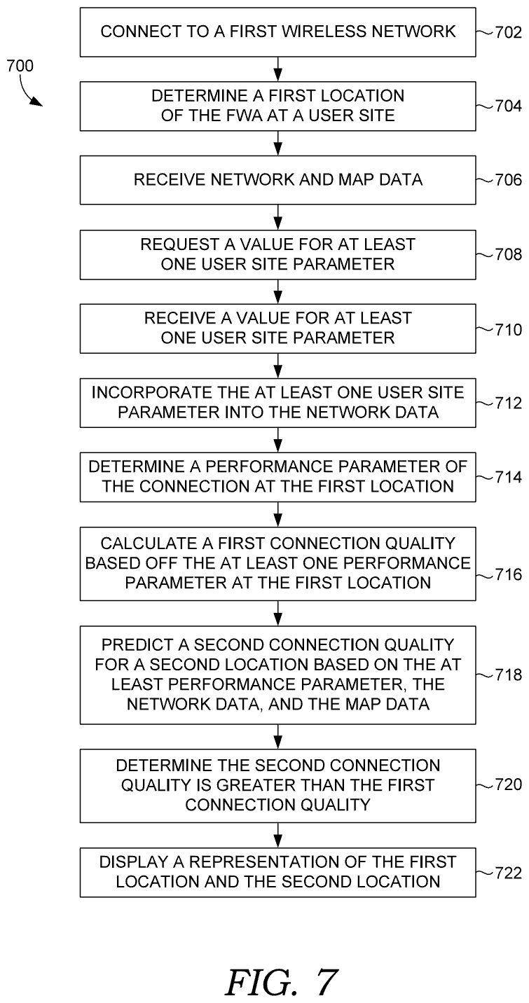

Continuing to FIG. 7, which illustrates an example flowchart of a method 700 for facilitating determination of an optimum placement location of an FWA device at a user site. At block 702, the FWA device connects to a first wireless network. As described in relation to FIG. 5, the first wireless network may be a telecommunications network such as LTE, 5G, 5G UC, 6G or similar. The connection to the network may be made through a first node. At block 704, a first location of the FWA device at the user site is determined. In some aspects, the location of the FWA device may be determined by a global positioning system, the first wireless network or receipt of network signals, or may be determined by a pre-determined user site location. At block 706, network data and map data are received. In some embodiments, the network and map data may be received by the FWA device, where the FWA device may determine the connection quality. In other aspects, the node or a server on the network receives the network data and the map data, which will be used to determine connection quality. In some aspects, the server and the FWA device may receive the map and the network data.

At block 708, a value for at least one user site parameter is requested. In some embodiments, this request is performed directly on the FWA device using an interactive or touch display. In other embodiments, a request for a user site parameter may be made via another device, such as a user's user equipment (i.e. a cell phone), which may receive messages or be linked to the network. The user site parameter may include information such as the number of stories the user site building has, location of windows, or the location within a user site that the user has access to, for example in an apartment building. The user site parameter that is requested may be determined by machine learning, which uses the network data and the map data to determine what additional information would be helpful in determining optimum placement of the FWA device. The request may include discrete options for a user, such as a “yes” or “no” answer or a number or a cardinal direction. In other embodiments, the request may allow for the user to return a narrative or free from response. At block 710, a value for at least one user site parameter is received. In some aspects, the value may be a discrete value or a narrative response from the user. In some embodiments, the response may determine that a new request for a value of a user site parameter is needed. The response may be received in the same manner that the request for the at least one user site parameter was made or the received value may be received from a different source. For example, the FWA device may display a request, however the user may input the response into a user device (e.g. cellphone) and return the response. At block 712, the received value for at least one user site parameter is incorporated into the network data. In further embodiments, machine learning may be used to process the user site parameter to make discreet and narrative responses into a means by which the values may be added to a calculation. In other embodiments, a machine learning module may use the received user site parameter data to alter or limit at least a portion of the received network data. For example, a received user site parameter may indicate there are no windows on a side of the building, and thus the theoretical maximum download speed for a signal passing through that side may be reduced accordingly.

At block 714, at least one performance parameter of the connection between the FWA device and the network at the first location is determined. The performance parameter may be a signal strength, a downlink speed, an uplink speed, a latency, or any another telecommunications performance parameter. At block 716, a first connection quality is calculated based on the at least the one performance parameter. The connection quality may be represented by a single performance parameter such as downlink speed or may be a combination of parameters, such as downlink speed and signal strength, or a relative value determined by a combination of parameters. In some embodiments, the relative value may be represented as a scaled score such as a number between 1 to 5 or 1 to 10. The relative value may also be an indication of predicted value such as; ‘poor,’ ‘fair,’ ‘good,’ ‘great,’ and ‘excellent.’ At block 718, a second connection quality is predicted for a second location based off of at least the one performance parameter, the network data, and the map data. In some aspects, the network data includes the received user site parameter value(s). The prediction may be calculated at the FWA device, a remote server on the network, at the base station, or another device connected to the network or the FWA device. In some aspects, the second connection quality may be the same performance parameter, combination of parameters, or relative value for a combination of parameters used for the first connection quality. At block 720, the first connection quality is compared to the second connection quality to determine the second connection quality is greater than the first connection quality. In some embodiments, if the first connection quality is greater than a predetermined percentage of the second connection quality, the process may conclude. At block 722, a representation of the first location and the second location is displayed. In some embodiments, the second location may be displayed with instructions and/or a predicted improvement. In other aspects, the first and second locations may be displayed on a map, which contains a user site with sufficient detail to instruct a user where to place the FWA device.

Having described the example embodiments discussed above of the presently disclosed technology, an example operating environment of an example user device (e.g., user device 108 of FIG. 1) is described below with respect to FIG. 8. User device 800 is but one example of a suitable computing environment, and is not intended to suggest any particular limitation as to the scope of use or functionality of the technology disclosed. Neither should user device 800 be interpreted as having any dependency or requirement relating to any particular component illustrated, or a particular combination of the components illustrated in FIG. 5.

As illustrated in FIG. 8, example user device 800 includes a bus 802 that directly or indirectly couples the following devices: memory 804, one or more processors 806, one or more presentation components 808, one or more input/output (I/O) ports 810, one or more I/O components 812, a power supply 814, and one or more radios 816.

Bus 802 represents what may be one or more busses (such as an address bus, data bus, or combination thereof). Although the various blocks of FIG. 8 are shown with lines for the sake of clarity, in reality, these blocks represent logical, not necessarily actual, components. For example, one may consider a presentation component, such as a display device, to be an I/O component. Also, processors have memory. Accordingly, FIG. 8 is merely illustrative of an exemplary user device that can be used in connection with one or more embodiments of the technology disclosed herein.

User device 800 can include a variety of computer-readable media. Computer-readable media can be any available media that can be accessed by user device 800 and may include both volatile and nonvolatile media, removable and non-removable media. By way of example, and not limitation, computer-readable media may comprise computer storage media and communication media. Computer storage media includes both volatile and nonvolatile, removable and non-removable media implemented in any method or technology for storage of information, such as computer-readable instructions, data structures, program modules, or other data. Computer storage media includes, but is not limited to, RAM, ROM, EEPROM, flash memory or other memory technology, CD-ROM, digital versatile disks (DVDs) or other optical disk storage, magnetic cassettes, magnetic tape, magnetic disk storage or other magnetic storage devices, or any other medium which can be used to store the desired information and which can be accessed by user device 800. Computer storage media does not comprise signals per se. Communication media typically embodies computer-readable instructions, data structures, program modules, or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media, such as a wired network or direct-wired connection, and wireless media, such as acoustic, RF, infrared, and other wireless media. One or more combinations of any of the above should also be included within the scope of computer-readable media.

Memory 804 includes computer storage media in the form of volatile and/or nonvolatile memory. The memory 804 may be removable, non-removable, or a combination thereof. Example hardware devices of memory 804 may include solid-state memory, hard drives, optical-disc drives, other hardware, or one or more combinations thereof. As indicated above, the computer storage media of the memory 804 may include RAM, Dynamic RAM, ROM, EEPROM, flash memory or other memory technology, CD-ROM, a cache memory, DVDs or other optical disk storage, magnetic cassettes, magnetic tape, magnetic disk storage or other magnetic storage devices, a short-term memory unit, a long-term memory unit, any other medium which can be used to store the desired information and which can be accessed by user device 800, or one or more combinations thereof.

The one or more processors 806 of user device 800 can read data from various entities, such as the memory 804 or the I/O component(s) 812. The one or more processors 806 may include, for example, one or more microprocessors, one or more CPUs, a digital signal processor, one or more cores, a host processor, a controller, a chip, a microchip, one or more circuits, a logic unit, an integrated circuit (IC), an application-specific IC (ASIC), any other suitable multi-purpose or specific processor or controller, or one or more combinations thereof. In addition, the one or more processors 806 can execute instructions, for example, of an operating system of the user device 800 or of one or more suitable applications.

The one or more presentation components 808 can present data indications via user device 800, another user device, or a combination thereof. Example presentation components 808 may include a display device, speaker, printing component, vibrating component, another type of presentation component, or one or more combinations thereof. In some embodiments, the one or more presentation components 808 may comprise one or more applications or services on a user device, across a plurality of user devices, or in the cloud. The one or more presentation components 808 can generate user interface features, such as graphics, buttons, sliders, menus, lists, prompts, charts, audio prompts, alerts, vibrations, pop-ups, notification-bar or status-bar items, in-app notifications, other user interface features, or one or more combinations thereof. For example, the one or more presentation components 808 can present a visualization that compares a plurality of inspections of one or more cores of a central processing unit and a visualization of each task of each of the plurality of inspections.

The one or more I/O ports 810 allow user device 800 to be logically coupled to other devices, including the one or more I/O components 812, some of which may be built in. Example I/O components 812 can include a microphone, joystick, game pad, satellite dish, scanner, printer, wireless device, and the like. The one or more I/O components 812 may, for example, provide a natural user interface (NUI) that processes air gestures, voice, or other physiological inputs generated by a user. In some instances, the inputs the user generates may be transmitted to an appropriate network element for further processing. An NUI may implement any combination of speech recognition, touch and stylus recognition, facial recognition, biometric recognition, gesture recognition both on screen and adjacent to the screen, air gestures, head and eye tracking, and touch recognition associated with the one or more presentation components 808 on the user device 800. In some embodiments, the user device 800 may be equipped with one or more imaging devices, such as one or more depth cameras, one or more stereoscopic cameras, one or more infrared cameras, one or more RGB cameras, another type of imaging device, or one or more combinations thereof, (e.g., for gesture detection and recognition). Additionally, the user device 800 may, additionally or alternatively, be equipped with accelerometers or gyroscopes that enable detection of motion. In some embodiments, the output of the accelerometers or gyroscopes may be provided to the one or more presentation components 808 of the user device 800 to render immersive augmented reality or virtual reality.

The power supply 814 of user device 800 may be implemented as one or more batteries or another power source for providing power to components of the user device 800. In embodiments, the power supply 814 can include an external power supply, such as an AC adapter or a powered docking cradle that supplements or recharges the one or more batteries. In aspects, the external power supply can override one or more batteries or another type of power source located within the user device 800.

Some embodiments of user device 800 may include one or more radios 816 (or similar wireless communication components). The one or more radios 816 can transmit, receive, or both transmit and receive signals for wireless communications. In embodiments, the user device 800 may be a wireless terminal adapted to receive communications and media over various wireless networks. User device 800 may communicate using the one or more radios 816 via one or more wireless protocols, such as code division multiple access (“CDMA”), global system for mobiles (“GSM”), time division multiple access (“TDMA”), another type of wireless protocol, or one or more combinations thereof. In embodiments, the wireless communications may include one or more short-range connections (e.g., a Wi-Fi® connection, a Bluetooth connection, a near-field communication connection), a long-range connection (e.g., CDMA, GPRS, GSM, TDMA, 802.16 protocols), or one or more combinations thereof. In some embodiments, the one or more radios 816 may facilitate communication via radio frequency signals, frames, blocks, transmission streams, packets, messages, data items, data, another type of wireless communication, or one or more combinations thereof. The one or more radios 816 may be capable of transmitting, receiving, or both transmitting and receiving wireless communications via mmWaves, FD-MIMO, massive MIMO, 3G, 4G, 5G, 6G, another type of Generation, 802.11 protocols and techniques, another type of wireless communication, or one or more combinations thereof.

Having identified various components utilized herein, it should be understood that any number of components and arrangements may be employed to achieve the desired functionality within the scope of the present disclosure. For example, the components in the embodiments depicted in the figures are shown with lines for the sake of conceptual clarity. Other arrangements of these and other components may also be implemented. For example, although some components are depicted as single components, many of the elements described herein may be implemented as discrete or distributed components or in conjunction with other components, and in any suitable combination and location. Some elements may be omitted altogether. Moreover, various functions described herein as being performed by one or more entities may be carried out by hardware, firmware, and/or software. For instance, various functions may be carried out by a processor executing instructions stored in memory. As such, other arrangements and elements (for example, machines, interfaces, functions, orders, and groupings of functions, and the like) can be used in addition to, or instead of, those shown.

Embodiments of the present disclosure have been described with the intent to be illustrative rather than restrictive. Embodiments described in the paragraphs above may be combined with one or more of the specifically described alternatives. In particular, an embodiment that is claimed may contain a reference, in the alternative, to more than one other embodiment. The embodiment that is claimed may specify a further limitation of the subject matter claimed. Alternative embodiments will become apparent to readers of this disclosure after and because of reading it. Alternative means of implementing the aforementioned can be completed without departing from the scope of the claims below. Certain features and sub-combinations are of utility and may be employed without reference to other features and sub-combinations and are contemplated within the scope of the claims.

Many different arrangements of the various components depicted, as well as components not shown, are possible without departing from the scope of the claims below. Embodiments in this disclosure are described with the intent to be illustrative rather than restrictive. Alternative embodiments will become apparent to readers of this disclosure after and because of reading it. Alternative means of implementing the aforementioned can be completed without departing from the scope of the claims below. Certain features and subcombinations are of utility and may be employed without reference to other features and subcombinations and are contemplated within the scope of the claims

In the preceding detailed description, reference is made to the accompanying drawings which form a part hereof wherein like numerals designate like parts throughout, and in which is shown, by way of illustration, embodiments that may be practiced. It is to be understood that other embodiments may be utilized and structural or logical changes may be made without departing from the scope of the present disclosure. Therefore, the preceding detailed description is not to be taken in the limiting sense, and the scope of embodiments is defined by the appended claims and their equivalents.

The invention claimed is:

1. A system for facilitating placement of a fixed wireless access (FWA) device, the system comprising:
the FWA device comprising one or more antennas for receiving a downlink signal from a serving cell and for transmitting an uplink signal to the serving cell, the FWA device further comprising a processor, the processor configured to:
determine values for a set of parameters for a plurality of placement locations, wherein the set of parameters comprises at least one of a downlink signal speed, an uplink signal speed, or a current location associated with the FWA device; and
generate a recommended placement location for the FWA device based on at least the values for the set of parameters for the plurality of placement locations.

2. The system of claim 1, wherein the system further comprises a user interface configured to display a visualization of one or more of the values of the set of parameters.

3. The system of claim 1, wherein the processor is further configured to:
request additional parameters from a user;
receive additional parameters; and
incorporate the additional parameters into the set of parameters.

4. The system of claim 2, wherein the user interface is configured to display a location visualization representing:
a cell location for the serving cell;
a first placement location;
a second placement location; and
the recommended placement location of the FWA device.

5. The system of claim 4, wherein the location visualization further comprises a coverage area for each of at least one cell, the at least one cell comprising the severing cell.

6. The system of claim 4, wherein the location visualization comprises an interactive map.

7. The system of claim 4, wherein the user interface is further configured to display a visualization of a user site, including identification of a floor or a level on which the FWA device is located.

8. The system of claim 1, further comprising a second FWA device, wherein the second FWA device is configured as the serving cell, wherein an interactive map comprises a visualization of the serving cell and the second FWA device.

9. The system of claim 1, further comprising:
a neural network, including a second processor, the second processor configured to:
request at least one variable;
receive the at least one variable;
receive the recommended placement location; and
generate a list of optimal placement locations.

10. A method for improving performance of a fixed wireless access (FWA) device, the method comprising:
connecting to a first network;
determining a first location of the FWA device;
receiving network data and map data;
determining at least one performance parameter of a connection between the FWA device and the first network;
calculating a first connection quality based on the at least one performance parameter at the first location;
predicting a second connection quality for a second location based on the at least one performance parameter, the network data, and the map data;
determining that the second connection quality is greater than the first connection quality; and
displaying a representation of the first location and the second location.

11. The method of claim 10 further comprising:
determining the first location of the FWA device is located outside of a permitted registration area;
outputting a notification; and
disconnecting from the first network.

12. The method of claim 10 further comprising:
determining the predicted connection quality is below a threshold;
receiving FWA identity data for local FWA devices; and
connecting to the first network via a second FWA device.

13. The method of claim 10 wherein a neural network is determining the suggested location of the FWA device.

14. The method of claim 13, further comprising:
requesting a value for at least one user site parameter;
receiving the value for the at least one user site parameter; and
incorporating the value for the at least one performance parameter into the network data.

15. The method of claim 10, further comprising:
initiating a second network;
connecting to at least one user-equipment (UE) on the second network;
designating each of the at least one UE with a device category from a plurality of device categories;
receiving input to prioritize a first device category of the plurality of device categories; and
implementing a packet optimizer to prioritize packets to and from UEs designated with the first device category.

16. Computer-readable storage media having computer-executable instructions embodied thereon that, when executed by one or more processors, cause the processors to:
at a first network, establishing a connection to a fixed wireless access (FWA) device;
determining a first location of the FWA device;
retrieving network data and map data associated with the FWA device;
determining at least one performance parameter of a connection between the FWA device and the first network;
calculating a first connection quality based on the at least one performance parameter at the first location;
predicting a second connection quality for a second location based on the at least one performance parameter, the network data, and the map data;
determining that the second connection quality is greater than the first connection quality; and
transmitting for display a representation of the first location and the second location.

17. The computer-readable storage media of claim 16, wherein the computer-readable storage media further comprises,
determining a power source to the FWA device has been interrupted; and
transmitting a signal for the FWA device to use low power mode and activate an on-device energy storage element to power the FWA device.

18. The computer-readable storage media of claim 16, wherein the computer-readable storage media further comprises,
determining the at least one performance parameter of a connection between the FWA device and the first network is below a threshold;
transmitting information to the FWA device to enable communications with a second network;
transmitting information to a relay FWA device to enable communications with the FWA device;
enable communications between the relay FWA device and the FWA device; and
at a first network, establishing a connection to an FWA device, via the second network.

19. The computer-readable storage media of claim 16, wherein the computer-readable storage media further comprises:
connecting to a plurality of user-equipment devices (UEs) via the FWA device;
assigning each of the plurality of UEs a device category; and
prioritizing at least one network resource based on the device category of the connected UEs.

20. The computer-readable storage media of claim 16, wherein the computer-readable storage media further comprises,
determining the FWA device is located outside of a registration area;
transmitting instructions for display at the FWA device; and
disconnect the FWA device the first network.
